(19) United States
(12) Patent Application Publication
(10) Pub. No.: US 2009/0031634 A1
(43) Pub. Date: Feb. 5, 2009

(54) Automation of Furniture, Household Appliances, and the Like

(75) Inventors: Michael Glanz, Koln (DE); Bernd Brieseck, Plettenberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennepetal (DE)

(21) Appl. No.: 12/185,671

(22) Filed: Aug. 4, 2008

(30) Foreign Application Priority Data
Aug. 3, 2007 (DE) 10 2007 036 747.5

(51) Int. Cl. E05F 1/00

(52) U.S. Cl. 49/324; 49/397

(57) ABSTRACT

Furniture or household appliances are disclosed having, according to the invention, at least one swiveling door leaf and at least one door closer or swivel leaf drive for the respective swiveling door leaf. The at least one door closer or swivel leaf drive has a driven shaft which is in an operative connection with the respective swiveling door leaf such that a rotation of the driven shaft causes a swiveling of this swiveling door leaf. This means that the rotation of the driven shaft causes an opening and closing of the swiveling door leaf.

### CROSS-REFERENCE TO RELATED APPLICATION

This application claims priority to German Application 10 2007 036747.5, the contents of which is incorporated herein by reference in its entirety.

### BACKGROUND OF THE INVENTION

1. Field of the Invention

The invention is directed to the automation of furniture, household appliances, and the like, having at least one swiveling door leaf.

2. Description of the Related Art

DE 696 29 824 T2 discloses a swivel leaf drive for refrigerators or the like constructed to swivel a swiveling door leaf in one of two possible directions. The drive comprises a drive motor coupled with a pinion gear on the driven side. The pinion gear engages a toothed rack so that a rotation by means of the driven shaft of the drive motor is transformed into a translation of the toothed rack. The toothed rack is coupled with a sliding plate. The sliding plate has an inclined stop face, respectively, at two ends. Between the stop faces, the sliding plate has, at a side facing the swiveling door leaf, a surface extending parallel to the swiveling door leaf in its closing position.

In a first phase of a door opening, the drive motor rotates in a first rotational direction and moves the toothed rack and the sliding plate in a first direction. The sliding plate impacts with its stop faces against a first roller which is arranged in a stationary manner at the swiveling door leaf. Due to the inclination of the stop face and the pressing of the stop face against said roller, the swiveling door leaf is forced in the opening direction and is therefore swiveled in the opening direction. If the swiveling door leaf is to be opened further, the drive motor is reversed and the sliding plate is moved in the opposite direction. The second stop face of the sliding plate now engages with a second roller, which is likewise arranged in a stationary manner at the swiveling door leaf, in an engagement identical to the previous one between the first stop face and the first roller so that the swiveling door leaf is opened further. Detection switches are additionally provided to detect the time of the reversal of the drive motor. On the whole, a relatively complicated driving process is needed to open a swiveling door leaf of this kind, which results in a relatively complex and therefore expensive construction.

DE 10 2004 021 912 A1 discloses a door opening drive for a safety cabinet in which a swiveling door leaf is opened and closed by a drive motor and a complex lever gear unit which leads to a complex and expensive drive.

### SUMMARY OF THE INVENTION

It is the object of the invention to provide automation for furniture, household appliances, and the like, which is simple and economical with respect to construction.

According to one embodiment of the invention, furniture and household appliances have at least one swiveling door leaf and at least one door closer or swivel leaf drive for the swiveling door leaf. The door closer or swivel leaf drive has a driven shaft which is in an operative connection with the swiveling door leaf such that a rotation of the driven shaft causes a swiveling of this swiveling door leaf; that is, the rotation of the driven shaft causes an opening and closing of the swiveling door leaf.

The driven shaft is preferably connected to at least one flap of a hinge at which the swiveling door leaf is swivelably mounted such that the driven shaft is fixed with respect to rotation. This offers the advantage that the door closer or swivel leaf drive can be used as a direct drive without a linkage.

This makes it possible to reduce the drive mechanism to a minimum. In the simplest case, a lengthening of the driven shaft toward the respective flap of a hinge. In this case, only additional installation space must be provided for the at least one door closer or swivel leaf drive.

In one embodiment, a connection piece is preferably arranged in each instance between two directly adjacent hinges of the at least one swiveling door leaf. Connection pieces of this kind can make the driving mechanism unnoticeable, i.e., practically invisible, for a user.

In one embodiment, the connection piece is preferably in operative connection with the driven shaft of the at least one door closer or swivel leaf drive. This makes it possible to transfer the rotational movement of the driven shaft to a plurality of flaps of different hinges.

In one embodiment of the invention, the at least one flap, which is accordingly driven, is arranged at the swiveling door leaf in a stationary manner. The respective door closer or swivel leaf drive is arranged in a stationary manner at an upright part of the furniture or household appliance. Alternatively, the opposite arrangement can also be carried out so that the at least one driven flap is arranged at the upright part of the furniture or household appliance in a stationary manner and the respective door closer or swivel leaf drive is arranged in a stationary manner at the swiveling door leaf to be swiveled.

Alternatively or in addition to this, it can be provided according to the invention that at least one door closer or swiveling door leaf is provided or operatively coupled at its driven shaft with a sliding arm which is arranged so as to be fixed with respect to rotation relative to it. An end remote of or facing away from the driven shaft is mounted so as to be guided in a slide rail that is preferably carried out by means of a sliding piece.

A sliding arm solution presents itself in cases where the force of the door closer or swivel leaf drive in direct coupling with a rotational axis of a swiveling door leaf is not sufficient and the dimensions of a door closer or swivel leaf drive of adequate capacity would exceed space limitations.

According to one embodiment of the invention, the slide rail is preferably arranged at the respective swiveling door leaf in a stationary manner. The respective door closer or swivel leaf drive is arranged in a stationary manner at the upright part of the furniture or household appliance. Alternatively, the opposite arrangement can be carried out so that the slide rail is arranged in a stationary manner at the upright part of the furniture or household appliance and the respective door closer or swivel leaf drive is arranged in a stationary manner at the swiveling door leaf to be swiveled.

In slide rail operation, the requirements with respect to opening and closing forces are still relatively demanding, which leads to door closers and swivel leaf drives of relatively large volume.

If a door closer or swivel leaf drive is used, an alternative arrangement by means of normal linkage or parallel arm linkage is provided according to one embodiment of the invention. The door closer or swivel leaf drive and the linkage are preferably arranged in the upright part of the furniture or household appliance. Accordingly, in a closed state of the swiveling door leaf, the linkage is located in an interior space of the furniture or household appliance. When the door closer or swivel leaf drive is arranged at the swiveling door leaf, the linkage is preferably fastened in a stationary manner to an inner side of a top or an upper termination of the furniture or household appliance, for example, by means of an angle.

According to one embodiment of the invention to arrange the respective door closer or swivel leaf drive in an upper or lower portion of the upright part of the furniture or household appliance. The respective door closer or swivel leaf drive can be accommodated in a particularly advantageous manner when additionally provided with a panel part. A panel part allows a respective door closer or swivel leaf drive to be accommodated in the furniture or household appliance so as to be virtually invisible, which is very advantageous in aesthetic respects. Further, there is less risk that a user will come into contact with the door closer or swivel leaf drive and cause damage or incur injury.

According to one embodiment of the invention, an elongated slot opening is provided in the panel in direction of the door closer or swivel leaf drive for the sliding arm or linkage. The panel part is preferably provided with a cover for the linkage and the door closer or swivel leaf drive. This sealing can be carried out by means of rubber lips that are arranged at the longitudinal edges of the slot opening and extend toward one another. The rubber lips overlap at their free ends. The sliding arm or linkage is located between the free ends of the rubber lips. This provides protection against possible injuries when operating the door closer or swivel leaf drive and prevents soiling of the drive.

The respective door closer or swivel leaf drive is preferably received in a completely closed receiving space of the furniture or household appliance. This provides maximum protection against dirt and any external mechanical.

The respective panel part and the respective door closer or swivel leaf drive to be accommodated therein are preferably constructed as a module. The respective door closer or swivel leaf drive is accommodated in a first part of the module. Further, according to the invention, the module has a second part which is operatively connected to the respective door closer or swivel leaf drive, i.e., is moved or driven by it. According to the invention, the first part is arranged in a stationary manner at the upright part of the furniture or household appliance. The second part is arranged in a stationary manner at the swiveling door leaf. Accordingly, the first part forms a component part of the upright part and the second part forms a component part of the swiveling door leaf. This arrangement makes it possible to outfit furniture or household appliances in a particularly simple manner during manufacture or to retrofit existing furniture and/or household appliance. Further, retrofitting is even simpler when fastenings, e.g., threaded holes that are already provided at the respective furniture or household appliance are used.

According to one embodiment of the invention, the door closers or swivel leaf drives are preferably arranged to be used at a DIN-right-handed swiveling door as well as at a DIN-left-handed swiveling door. In the simplest case, this is carried out by means of a driven shaft which projects at both ends from a housing of the respective door closer or swivel leaf drive in such a way that the door closer or swivel leaf drive can be operatively connected at both ends of the driven shaft to a hinge flap.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIGS. 1A, 1B depict a cabinet according to a first embodiment form of the invention provided with a swivel leaf drive which is used as a direct drive;

FIGS. 2A-2N depict operative couplings between the driven shaft of the swivel leaf drive and the swiveling door leaf from FIG. 1 in different constructions;

FIGS. 3A-3B depict an upper part of a piece of furniture constructed as a cabinet according to second embodiment form of the invention;

FIGS. 4A-4B depict an upper part of a household appliance constructed as a freezer cabinet according to a third embodiment form of the invention;

FIGS. 5A-5C depict a household appliance constructed as a freezer cabinet according to a fourth embodiment form of the invention;

FIGS. 6A-6B depict a piece of furniture constructed as a cabinet according to a fifth embodiment form of the invention;

FIGS. 7A-7B depict a lower part of a piece of furniture constructed as a cabinet according to a sixth embodiment form of the invention;

FIGS. 8A-8C depict a household appliance constructed as a freezer cabinet according to a seventh embodiment form of the invention; and

FIGS. 9A-9C depict a household appliance constructed as a freezer cabinet according to an eighth embodiment form of the invention.

### DETAILED DESCRIPTION OF THE PRESENTLY PREFERRED EMBODIMENTS

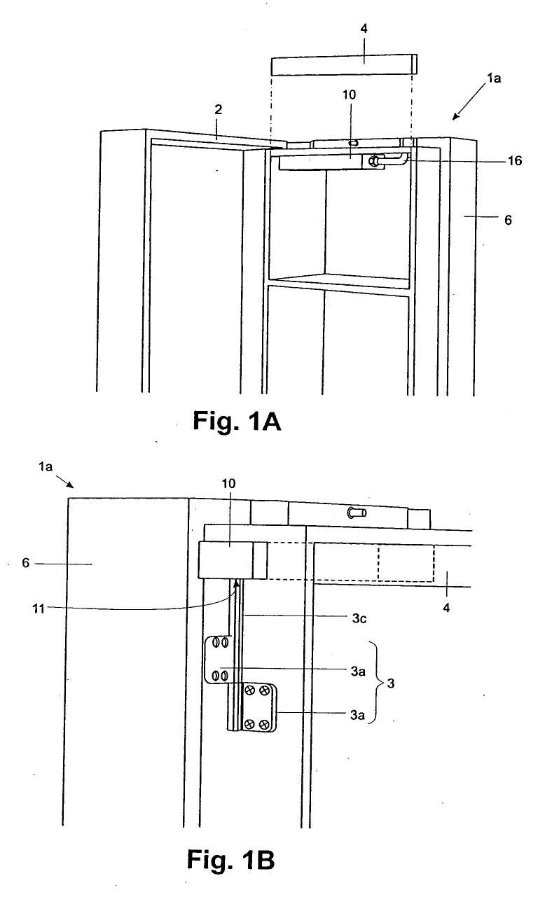

FIG. 1A shows a section of a piece of furniture 1a constructed as a cabinet according to a first embodiment of the invention. The cabinet has an upright part 6 and a swiveling door leaf 2. As can be seen, a swivel leaf drive 10 is accommodated in a top area of an upper shelf of the cabinet. Further, a connection cable 16 of the swivel leaf drive 10 is arranged in the top area. In the example shown here, the swivel leaf drive 10 is arranged at an underside of a top part of the cabinet.

The swivel leaf drive 10 is preferably concealed by a panel part 4 so that the swivel leaf drive 10 is virtually unseen.

Alternatively, the swivel leaf drive 10 is accommodated in a closed space. This can be carried out, for example, in that the swivel leaf drive 10 is fastened to a board, e.g., by screws, nails, glue, rivets, or the like. The board has the shape of a shelf base. The panel part 4 is arranged at a front rim of the board considered from the user's perspective. The panel part extends from the board in a direction toward the top area of the cabinet, that is, upward, referring to FIG. 1A. In the assembled state, the board and panel part 4 cover the swivel leaf drive 10 preferably completely at the bottom and in the front. This protects against damage or improper handling by inexperienced persons.

As can be seen from FIG. 1B, the swivel leaf drive 10 is arranged continuously through a left-hand side wall of the upright part 6. An end of a driven shaft 11 of the swivel leaf drive 10 remote of the swivel leaf drive 10 is connected to a pin 3c so as to be fixed with respect to rotation relative to pin 3c or is formed integrally therewith. The pin 3C is arranged so as to be fixed with respect to rotation relative to the swiveling part formed by either of flaps 3a of a hinge 3.

Alternatively, the driven shaft 11 of the swivel leaf drive is operatively coupled with a gear unit that is operatively connected in turn to either of the flaps 3a.

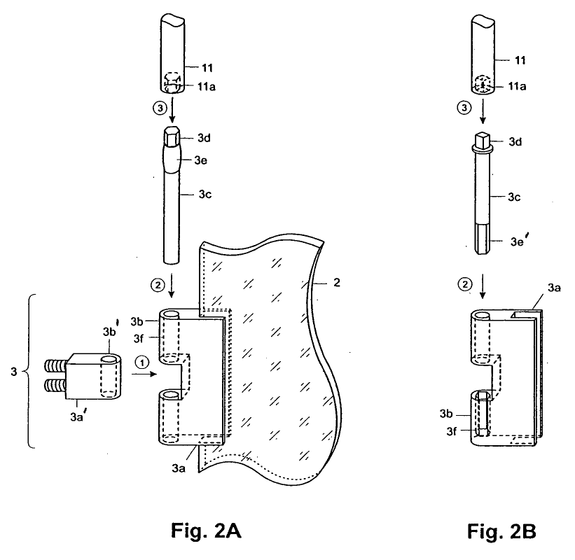

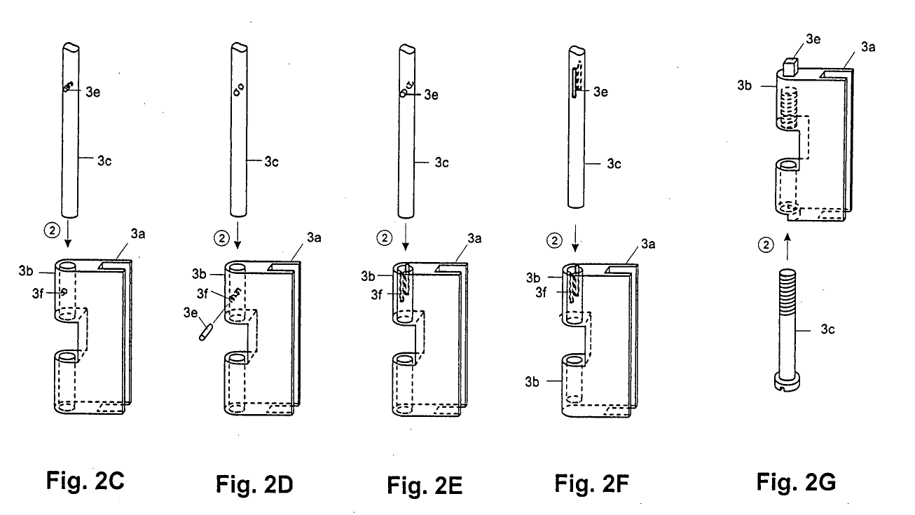

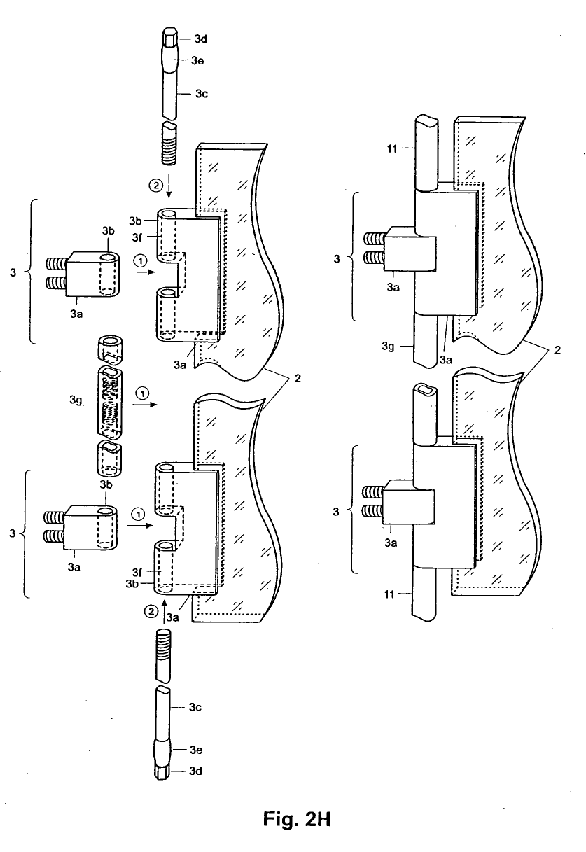

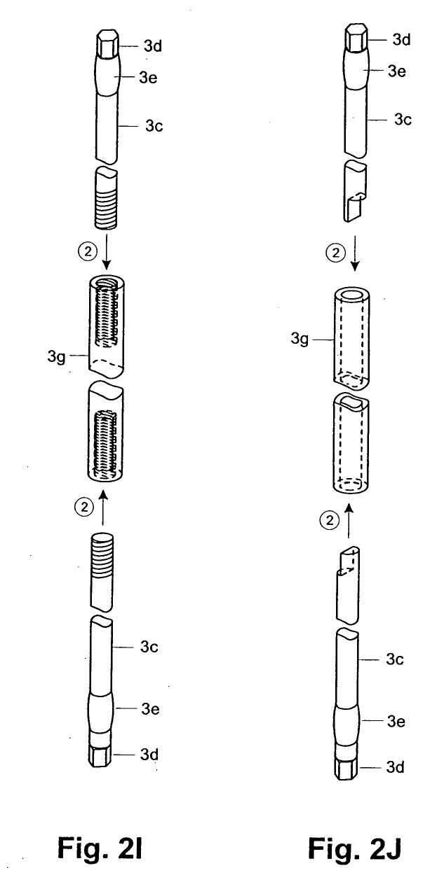

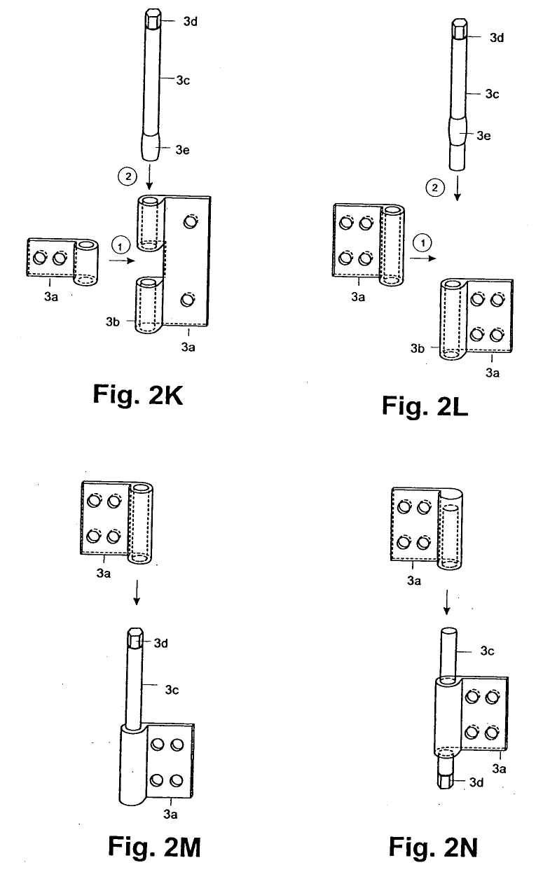

FIGS. 2A and 2B show operative couplings between the driven shaft 11 and a flap 3a of at least one hinge 3.

Preferably, the operative couplings have a pin 3c has a drive portion 3d which serves to operatively couple with a driven portion 11a of the driven shaft 11 of a swivel leaf drive 10 (not shown).

In order to enable a simple installation and assembly of the operative connection between the swiveling door leaf 2 and the driven shaft 11, it is preferably provided that the drive portion 3d is constructed so as to complement the shape of the driven portion 11a. When the driven shaft 11 is placed on the pin 3c, a positively engaging connection results that particularly simplifies assembly.

However, any other type of rotational engagement is possible. For example, the driven shaft 11 and pin 3c can be screwed, pinned, welded, glued, soldered, or the like, together to be fixed with respect to relative rotation.

In FIG. 2, the circled numbers designate the number of a step in the assembly of a respective hinge 3. It should be noted that no specific order is designated as these components can be assembled in any practical order.

According to FIG. 2A, the driven shaft 11a is constructed in the form of a hexagon socket, for which purpose the drive portion 3d is constructed as a hexagon insert bit. Further, the pin 3c has a first drive portion 3e in the form of a thickening.

When the pin 3c is inserted (step \textcircled{2}), the pin 3c is clamped by an upper joint 3b of a right-hand flap 3a of a hinge 3 referring to FIG. 2A. In this example, a through-opening of the upper joint 3b forms a drive portion 3f. The clamping force between the pin 3c and the drive portion 3f must be sufficiently high so that the pin 3c, when rotated, rotates the upper joint 3b and therefore swivels a swiveling door leaf 2 which is arranged at the hinge 3. The thickening preferably comprises an elastic plastic. The thickening is preferably constructed as a sleeve which is slid on or screwed to the pin 3c. The pin 3c preferably has an external thread portion at a corresponding location.

Further, every hinge 3 has another flap 3a on the left-hand side referring to FIG. 2A, which is arranged in a stationary manner at an upright part 6 (not shown), for example, of a cabinet, for example, by means of threaded pins.

In one embodiment, hinge 3 is preferably assembled as follows:
the left-hand flap 3a, referring to FIG. 2A, is inserted with its joint 3b in an area between two joints 3b of the right-hand flap 3a referring to FIG. 2A (step \textcircled{1}),
the pin 3c is inserted into the joints 3b of the flaps 3a of the hinge 3 (step \textcircled{2}), and
the driven portion 11a of the driven shaft 11 of a swivel leaf drive 10, not shown, is placed on the drive portion 3d of the pin 3c, or the drive portion 3d of the pin 3c is inserted into the driven portion 11a of the driven shaft 11 of the swivel leaf drive 10 (step \textcircled{3}).

A swiveling door leaf 2 is mounted in the right-hand flap 3a of the hinge 3 referring to FIG. 2A. In case of an all-glass swiveling door leaf 2, shown here, this can be carried out by means of clamping, for example.

Instead of clamping between pin 3c and corresponding joint 3b, a positively engaging and/or frictionally engaging operative coupling can be provided between the pin 3c and a respective joint 3b of a hinge flap 3a.

In coupling shown in FIG. 2B according to another embodiment form of the invention, the pin 3c has, instead of a thickening in a lower region 3e, a driven portion 3e′ which preferably has a non-round outer contour. The outer contour is shaped as a polygon such as a hexagon, octagon, square, or the like insert bit.

The driven portion 3e has a maximum width and/or depth which is preferably slightly smaller than an inner diameter of a through-opening of the upper joint 3b of the flap 3a and of the arranged joint 3b′ of the flap 3a, not shown, which is arranged at an upright part 6. Accordingly, it is ensured that the pin 3c slides through easily. A lower joint 3b, referring to the example, is formed by a recess complementing the shape of the driven portion 3e so that a positively engaging coupling results between the pin 3c and the lower joint 3b. This recess accordingly forms a drive portion 3f. The recess preferably ends above a lower end of the lower joint 3b, that is, it is not continuously formed. In this way, the driven portion 3e of the pin 3c is received so as to be invisible in the assembled state.

In the example shown herein, the driven portion 11a of the driven shaft 11 has the shape of a square socket, which is why the drive portion 3d of the pin 3c has the shape of a square pin. To prevent it from falling out, the pin 3c can have, in addition, a collar having a width and/or depth that is greater than the inner diameter of the upper joint 3b.

FIG. 2C shows an operative coupling according to another embodiment form of the invention. A ball that is mounted so as to be springingly pretensioned toward an outer side of the pin 3c forms the drive portion 3e. For the sake of simplicity, the drive portion 3d of the pin 3c is not shown. In place of the ball, the pin 3c has an opening whose internal dimensions are slightly smaller than the outer diameter of the ball. The ball projects outward to a certain extent from the pin 3c. The upper joint 3b of the flap 3a in the example shown here has, at one inner side of the through-opening, a drive portion 3f formed by a recess. The recess serves to receive the projecting portion of the ball of the pin 3c. The ball is received in the recess when the pin 3c is inserted (step \textcircled{2}) and is accordingly arranged between the pin 3c and the upper joint 3b. This creates the operative coupling by means of which the pin 3c can securely drive the mounted swiveling door leaf 2, not shown, during a rotation.

Alternatively, in another operative coupling shown in FIG. 2D according to another embodiment form of the invention, both the pin 3c and a joint 3b of a respective flap 3a have a through-opening. When the pin 3c and joint 3b are assembled, i.e., the through-openings are aligned with one another, a drive portion 3e formed as a pin is slid into these through-openings. The pin 3c and joint 3b are accordingly connected to one another so as to be fixed with respect to relative rotation.

Alternatively, in another operative coupling shown in FIG. 2E according to another embodiment form of the invention, a driver arrangement is provided. The pin 3c preferably has, as driven portion 3e, two projections that are arranged so as to extend in horizontal direction and preferably project from outer sides that are preferably located opposite from one another and remote of one another.

The flap 3a has as drive portion 3f vertically extending grooves in the upper joint 3b in its through-opening. When put together, the projections of the pin 3c engage in the grooves and accordingly cause the pin 3c to be arranged in the corresponding flap 3a so as to be fixed with respect to relative rotation. When the grooves do not extend over an entire length of the through-opening, bases of the grooves, i.e., the horizontal terminating surfaces of the grooves in FIG. 2E, form a support for the projections so that the pin 3c cannot fall out.

Instead of the pin-shaped projections shown in FIG. 2E, the driven portion 3e of the pin 3c according to another embodiment form of the invention shown in FIG. 2F can be formed by means of projections which preferably have a shape complementing that of the grooves. Accordingly, when the pin 3c is inserted into the grooves, a positively engaging operative coupling is formed between the pin 3c and the corresponding flap 3a.

A recess, which is formed in the lower joint 3b of the flap 3a for receiving a lower portion of the pin 3c preferably, ends above a lower end of the lower joint 3b, that is, it is not continuous.

Grooves that are rectangular in cross section are shown by way of example as drive portion 3f. However, any other type of cross-sectional shape is possible as long as the pin 3c and the joint 3b are arranged so as to be fixed with respect to relative rotation.

The constructions described above can also be formed in the other respective joint 3b of the flap 3a instead of, or in addition to, the joint 3b shown.

Alternatively, as is shown in FIG. 2G, the pin 3c can be formed integral with an end facing the swivel leaf drive 10; that is, according to FIG. 2G, the upper joint 3b of the flap 3a has a drive portion 3e which is directed upward and which is constructed as a square pin, for example, according to FIG. 2G. In this case, a pin 3c functions merely as a bearing axle for the other flap 3a (not shown) of the associated hinge 3 and is preferably constructed as a screw which is screwed into the upper joint 3b proceeding from an end remote of the swivel leaf drive 10.

The through-opening of the lower joint 3b of the flap 3a is preferably provided with a recess which is constructed so as to complement an outer shape of the screw head so that the screw terminates flush with the flap 3a when screwed together. If a countersink screw is used, the recess can have the shape, e.g., of a truncated cone.

Referring to the operative couplings described above, the pins 3c can have outer dimensions that are preferably slightly greater than the inner dimensions of the respective through-openings so that the pins 3c are clamped in at least one through-opening in such a way that they cannot fall out. The clamping force can be substantially smaller than in the embodiment form shown in FIG. 2A.

FIG. 2H shows an advantageous further development for the operative couplings described above. In the example shown herein, two pins 3c are provided, one for an upper hinge 3 and one for a lower hinge 3. Accordingly, each pin 3c preferably has a drive portion 3d for coupling with a swivel leaf drive 10. This makes possible the energy necessary for moving the swiveling door leaf 2 on two swivel leaf drives 10. This makes it possible to automatically drive swiveling door leafs 2 that are heavier than those that could be driven by one swivel leaf drive 10.

Another advantage consists in that in case of the failure of one swivel leaf drive 10, the other is still capable of moving the swiveling door leaf 2 with reduced force and speed.

Alternatively, one swivel leaf drive 10 can be kept in reserve. In this case, the swivel leaf drives 10 are operatively connected by couplings. Only one swivel leaf drive 10 is operatively connected to the swiveling door leaf 2 at any one time. If a swivel leaf drive 10 fails, it is disconnected from the swiveling door leaf 2 and the other swivel leaf drive 10 is brought into an operative connection with the swiveling door leaf 2. The respective operatively connected swivel leaf drive 10 can be tested for proper functioning, for example, by monitoring a respective motor current.

A connection piece 3g is arranged between the hinges 3 in FIG. 2H. The connection piece 3g and the two pins 3c are constructed in such a way at ends facing one another that each pin 3c can be brought into rotational engagement with an end of the connection piece 3g.

According to the construction shown in FIG. 2H, the pins 3c are screwed together with the connection piece 3g. Internal thread portions provided in the connection piece 3g are formed in such a way that they are at a relatively small distance from one another. This limits an area of the connection piece 3g on which torsional forces are exerted during the rotation of at least one of the pins 3c to a relatively small area of the connection piece 3g.

The connection piece 3g preferably has outer dimensions that correspond to the outer dimensions of directly adjoining joints 3b of respective flaps 3a. This means that the connection piece 3g and the corresponding joint 3b merge with one another with respect to their outer shape and accordingly are flush with one another or form smooth transitions as is shown on the right-hand side of FIG. 2H.

The described solution makes it possible to design the force-transmitting parts for the respective swiveling door leaf 2, that is, pins 3c and connection piece 3g, to be virtually invisible to observers. These force-transmitting parts appear as continuous round rods in connection with corresponding receiving portions of the hinges 3.

If there are more than two hinges 3 per swiveling door leaf 2, a connection piece 3g is provided between each pair of directly adjacent hinges 3. For the operative connection between two directly adjacent connection pieces 3g, a pin is provided which preferably has at both ends, respectively, an external thread portion according to the pins 3c shown above and is accordingly screwed with the connection pieces 3g to be operatively connected.

When only one swivel leaf drive 10 is used, the drive portion 3d is preferably missing from a respective pin 3c to be operatively coupled with the door closer or swivel leaf drive 10. Further, a pin 3c of this kind preferably does not protrude from a corresponding flap 3a with one end remote of the connection piece 3g. In this case, the rotational engagement between this pin 3c and the associated connection piece 3g preferably serves to prevent the pin 3c from falling out.

Alternatively, in case of only one swivel leaf drive 10, the pin 3c which is not driven substantially corresponds in length to the driven pin 3c. The protruding free end of the pin 3c that is not driven is preferably received in an axle. The axle corresponds with respect to its outer contour to a driven shaft of a door closer or swivel leaf drive 10 that is used with the driven pin 3c so that the resulting overall impression is of a round rod provided with hinges 3. The axle itself is received by its free end in a bearing that can be accommodated in a housing of the cabinet. This housing preferably has the outer shape of the used swivel leaf drive 10 and is similarly accommodated in the cabinet.

When more than two hinges 3 are provided, each pin 3c arranged between two connection pieces 3g is preferably provided with external thread portions arranged at both ends.

The internal thread portions of the connection piece 3g shown in FIG. 2H can be formed by an individual internal thread portion.

The operative coupling according to an embodiment form of the invention shown in FIG. 2I differs from the embodiment form shown in FIG. 2H in that the inner thread portions of a respective connection piece 3g start at a respective end facing a respective pin 3c and are formed so as to extend toward one another. That is, the pins 3c can be shorter than in the operative coupling according to FIG. 2H. This is possible when the torsional forces during the rotation of a respective pin 3c are not sufficient for overcoming the connection piece or connection pieces 3g so that a reliable operation is further ensured.

In the operative couplings described with reference to FIGS. 2H and 2I, a respective connection piece forms a gear unit part, i.e., it is rotated by means of at least one pin 3c.

In an operative coupling shown in FIG. 2J according to another embodiment form of the invention, the one connection piece 3g which is shown by way of example is not constructed as a force-transmitting part but rather as a bearing sleeve. The pins 3c have no external thread portions for screwing into a respective connection piece 3g. They are constructed in such a way at ends facing one another that they can be brought into rotational engagement with one another in a positive and/or frictional engagement. In the example shown in FIG. 2J, the pins 3c have, at said ends, a projection with a half-circular cross section. When assembled, these two projections have a shape in cross section that corresponds to a shape of the pin 3c preferably in the remaining region.

Of course, the ends facing one another can be shaped like the drive portions 3d and driven portions 11a described above.

In this embodiment form, it is possible to seal the connection piece 3g or connection pieces 3g with respect to the directly adjoining flap 3a or to form it or them integral with one, or even both, of the flaps. Further, a particularly simple assembly is possible in this case; the parts need merely be put together.

FIG. 2K shows an operative coupling according to another embodiment form of the invention. The hinge is formed by means of two flaps 3a, both of which have fastening openings. The pin 3c according to FIG. 2K is shaped similar to the pin 3c of FIG. 2A except that the driven portion 3e is brought into an operative connection with a lower joint 3b of the flap 3a on the right-hand side referring to FIG. 2K. The two flaps 3a each have a through-opening for receiving the pin 3c.

In an operative coupling shown in FIG. 2L according to another embodiment form of the invention, the right-hand flap 3a has only one joint 3b with which the pin 3c is brought into rotational engagement with its drive portion 3e.

FIG. 2M shows an operative coupling according to another embodiment form of the invention, In this case, the pin 3c is formed integral with the flap 3a to be driven, that is, with the lower flap 3a in this case.

FIG. 2N shows an operative coupling in which the second drive portion 3d of the pin 3c, directed downward below the flap 3a to be driven, which in this case is arranged at the bottom, is formed integral with the flap 3a. A portion of the pin 3c projects from an upper rim of the lower flap 3a and is received in a receiving opening of an upper flap 3a so as to be freely rotatable. The receiving opening of the upper flap 3a is preferably not constructed in a continuous manner. This protects against any contamination.

The embodiment forms shown in FIG. 2 are interchangeable with respect to their parts and can be combined with one another. For example, the solutions shown in FIGS. 2H-2J can be used with hinges according to FIGS. 2K-2N, or vice versa. When the at least one swivel leaf drive 10 is arranged at the swiveling door leaf 2, the at least one pin 3c that is used is in rotational engagement with a flap 3a which is fastened at an upright part and not at the swiveling door leaf 2. In case of the arrangements shown in FIGS. 2A and 2H, for example, the pin 3c would accordingly engage with a left-hand flap 3a in rotational engagement.

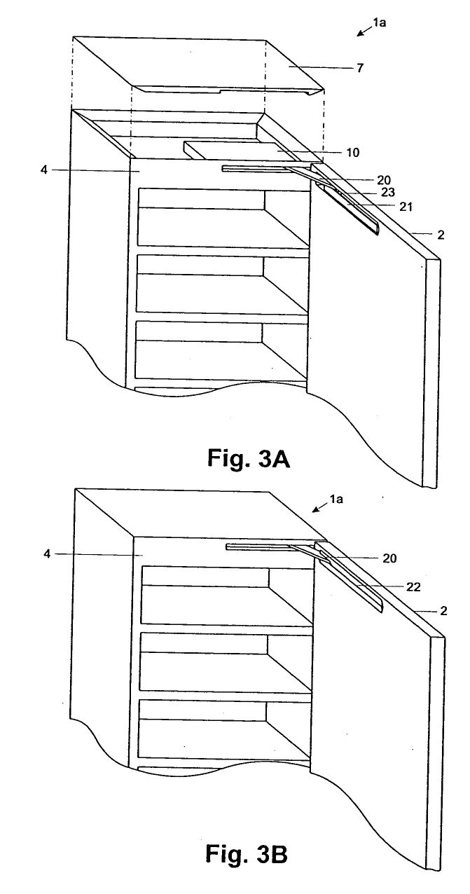

FIG. 3A shows an upper part of a piece of furniture 1a constructed as a cabinet according to a second embodiment form of the invention. In contrast to the first embodiment form, the swivel leaf drive 10 is accommodated in an upper receiving space of the cabinet 1a. The swivel leaf drive 10 is operatively connected to a slide rail 21 by means of a sliding arm 30 and a sliding piece 23, this slide rail 21 being accommodated in turn in the swiveling door leaf 2 so as to be stationary. The sliding arm 20 extends from the swivel leaf drive 10 through a front panel part 4 of the cabinet 1a to the slide rail 21. The panel part 4 can be formed integral with the cabinet 1a. A cover part 7 which has a cutout for the sliding arm 30 in the example shown in FIG. 3A is arranged on the receiving space. This serves to optimize the height of the receiving space to a minimum.

FIG. 3B shows the cabinet from FIG. 3A in the assembled state. It can be seen that the swivel leaf drive 10 is received so as to be invisible to a user. Only the sliding arm 20 can be seen by the user. A cover 22 is preferably arranged at a side of the slide rail 20 facing the swivel leaf drive 10 when the swiveling door leaf 2 is closed. On one hand, this cover serves to protect the slide rail 21 from dirt; on the other hand, it can minimize the risk that a user will suffer injury from pinching a finger, for example.

The cover 22 can be formed, for example, by two lips which face one another and are made of a relatively stiff, elastic material and are arranged so as to overlap one another. The sliding arm 20 extends between the lips.

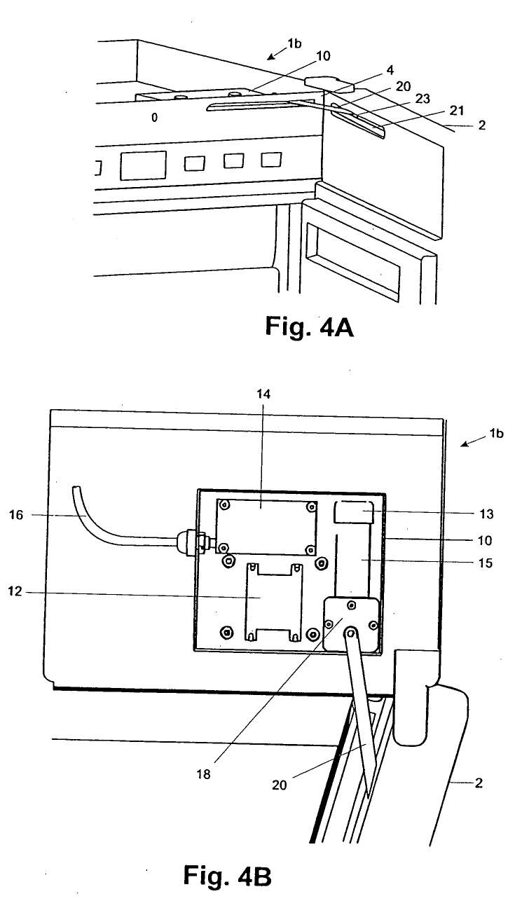

FIG. 4A shows an upper part of a household appliance 1b constructed as a freezer cabinet according to a third embodiment form of the invention, The construction corresponds substantially to the construction of the cabinet shown in FIG. 3. The swivel leaf drive 10 is preferably integrated in a separate drive module which will be described in the following.

FIG. 4B shows a top view of the freezer cabinet from FIG. 4A. In addition to a drive motor 15, the swivel leaf drive 10 preferably comprises a gear unit 18 by which the drive motor 15 is operatively connected to the sliding arm 20. Further, an incremental encoder 13 is preferably arranged at an end of the drive motor 15 remote of the sliding arm 20. The incremental encoder 13 is advantageously connected to a control circuit 12 for the drive motor 15. The control circuit 12 is preferably set up to determine an opening angle of the swiveling door leaf 2 based on signals from the incremental encoder 13 and to control or operate the drive motor 15 in a suitable manner. Further, the control circuit 12 can be provided with a storage in which various control programs for different operating modes and possibly parameters for the operation are stored.

For example, the operating modes can cause the swiveling door leaf 2 to be held open for a predetermined, adjustable time. Further, sensors are preferably provided, e.g., in the form of photodiodes or radar sensors, for detecting any obstacles in the movement path of the swiveling door leaf. If such an obstacle is detected, the monitoring of the opening time is preferably prevented from starting as long as an obstacle is detected. In addition, an audible alarm, for example, is preferably emitted.

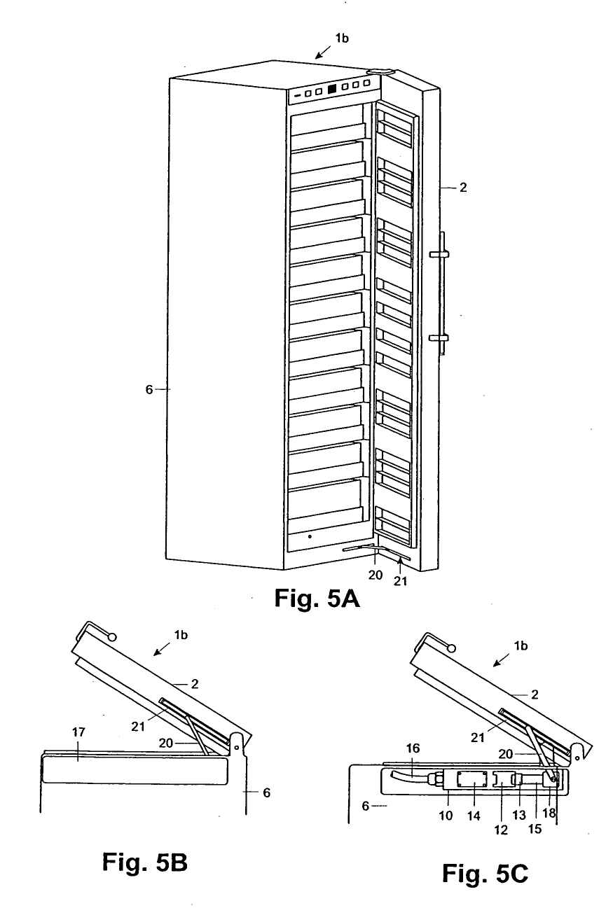

FIG. 5 shows a household appliance 1b constructed as a freezer cabinet according to a fourth embodiment form of the invention, As is shown in FIG. 5A, a receiving portion in which a swivel leaf drive 10 is arranged and which is preferably provided with a sliding linkage is located in a lower portion of the upright part 6.

FIGS. 5B and 5C show a plan view of the freezer cabinet from the bottom. The swivel leaf drive 10 is accommodated in a receiving space which is preferably closed by a cover 17 shown in FIG. 5B to protect against soiling. In the example shown herein, the power supply 14, control circuit 12, incremental encoder 13, drive motor 15 and any gear units 18 are arranged in tandem one behind the other.

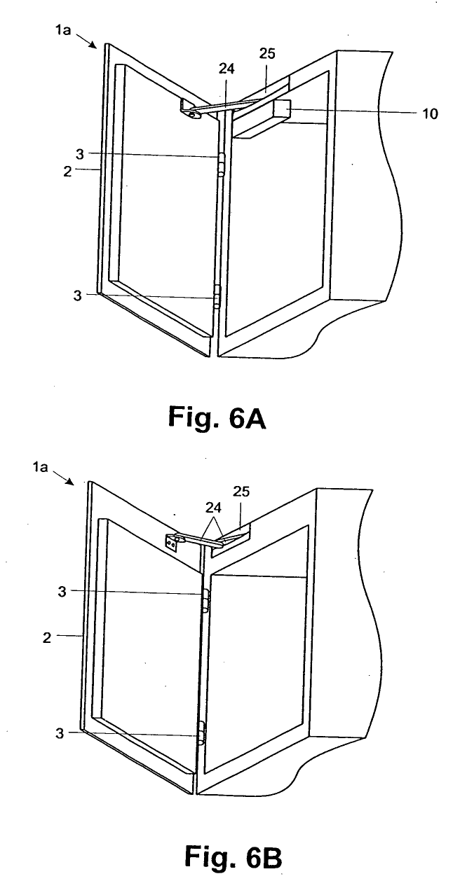

FIG. 6 shows a piece of furniture 1a constructed as a cabinet according to a fifth embodiment example of the invention. In contrast to the slide rail linkages described above, the swivel leaf drive 10 according to FIG. 6A is operatively connected to the swiveling door leaf 2 by a normal linkage. Only one arm 24 of the normal linkage is visible because of the linkage cover 25. In a manner analogous to the embodiment form according to FIG. 1A, the swivel leaf drive 10 is arranged below a top area and can be concealed by means of a panel, not shown. Alternatively, the swivel leaf drive 10 is accommodated in a completely closed receiving space so as to be virtually invisible to the user. The cover 25 for the normal linkage is preferably constructed like the slide rail cover 22 described above.

FIG. 6B shows the cabinet according to FIG. 6A in connection with a swivel leaf drive 10 which is operatively connected with a swiveling door leaf by a parallel arm linkage, specifically in a completely closed receiving space in this case.

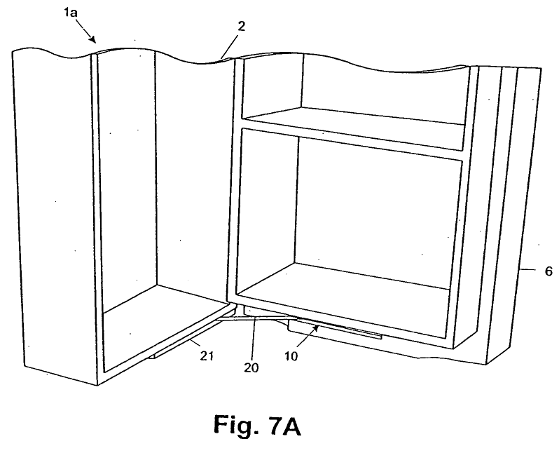

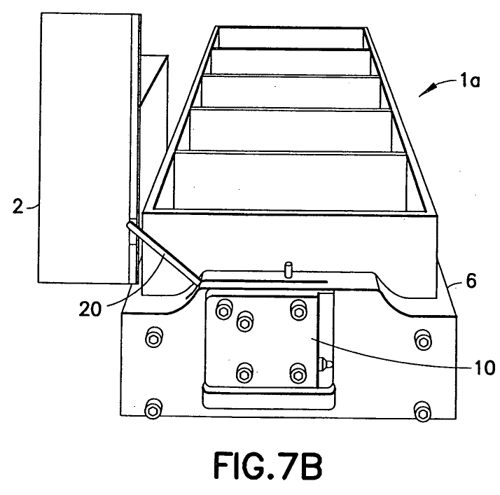

FIG. 7 shows a piece of furniture 1a constructed as a cabinet according to a sixth embodiment form of the invention. As is shown in FIG. 7A, the swivel leaf drive 10 is accommodated in a bottom region of the cabinet. For this purpose, the cabinet preferably has a receptacle in the upright part 6 for the swivel leaf drive 10. An opening in the form of a slot for the passage of a sliding arm 20 is provided on one side facing the swiveling door leaf 2 in its closed position. A slide rail 21 is arranged in the swiveling door leaf 2 at a corresponding location. A sliding piece 23, not shown, which is coupled with the slide rail 21 is received so as to be guided in the slide rail.

FIG. 7B shows the cabinet from FIG. 7A in a bottom view. As can be seen, the swivel leaf drive 10 is constructed so as to be accessible from below. This makes it possible to adjust the swivel leaf drive 10 in the assembled state. Alternatively, a cover 17 offering protection against soiling can be provided analogous to FIG. 5B.

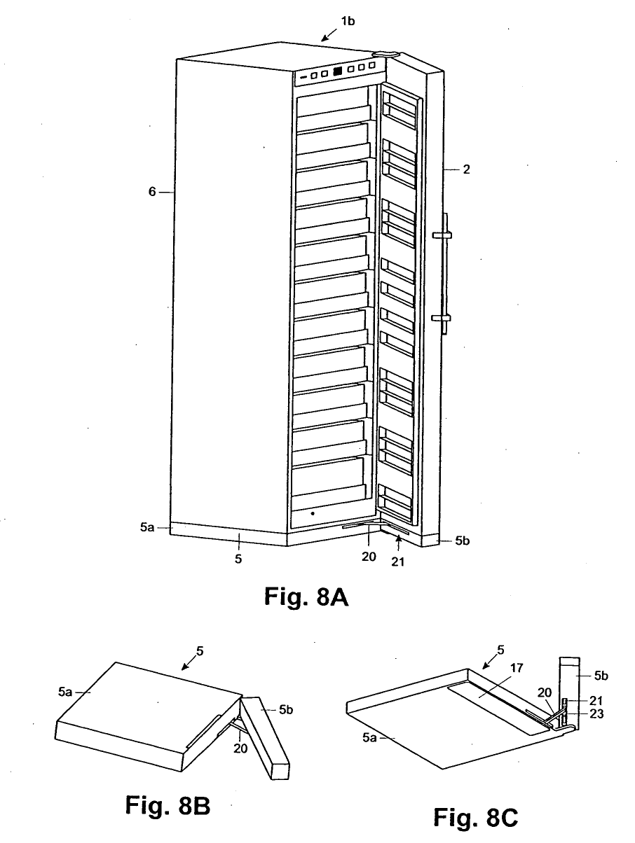

FIG. 8 shows a household appliance 1b constructed as a freezer cabinet according to a seventh embodiment form of the invention. As is shown in FIG. 8A, the swivel leaf drive 10 is accommodated in a lower portion of the freezer cabinet, specifically in a separately constructed drive module 5.

The drive module 5 comprises a first part 5a, in which the swivel leaf drive 10 is accommodated, and a second part 5b in which a slide rail 21 is accommodated in the present case. A sliding arm 20 which operatively connects the swivel leaf drive 10 and the slide rail 21 with one another extends between the two parts 5a, 5b. At an underside, the first part 5a preferably has a cover 17 which is arranged in a removable manner, for example, for servicing purposes or to simplify assembly of the swivel leaf drive 10.

The first part 5a is fastened, preferably detachably, below the upright part 6 of the freezer cabinet at the upright part 6. Similarly, the second part 5b is fastened, preferably detachably, below the swiveling door leaf 10 of the freezer cabinet at the swiveling door leaf 10 so as to be stationary. The two parts 5a, 5b are preferably fastened to one another in a swivelable manner, which facilitates assembly of the drive module 5.

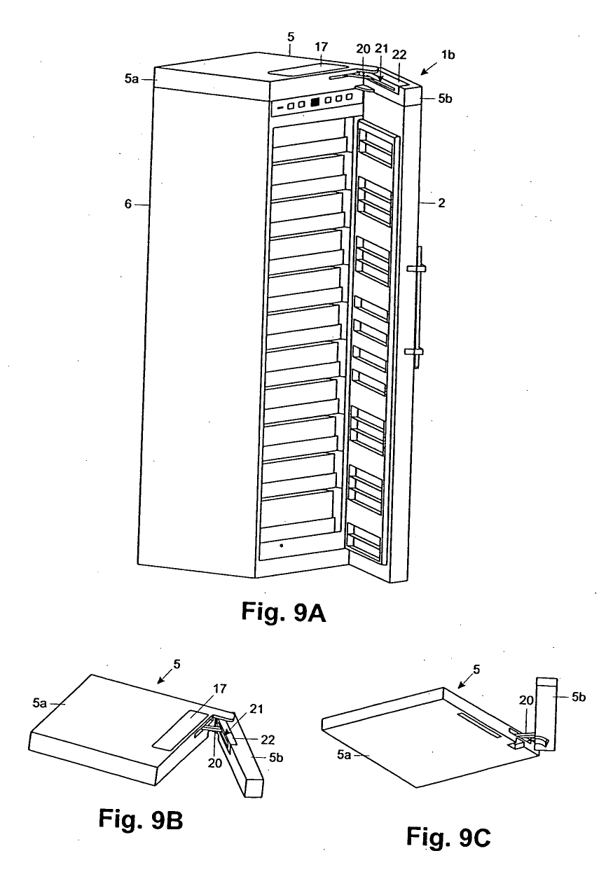

FIG. 9 shows a household appliance 1b constructed as a freezer cabinet according to an eighth embodiment form of the invention. This embodiment form is similar to the seventh embodiment form of the invention. The difference consists in that the drive module 5 is accommodated in an upper portion of the freezer cabinet according to FIG. 9A. A slide rail cover 22 is provided at the second part 5b of the drive module 5. The slide rail cover 22 is preferably designed in such a way that it is arranged so as to extend around an edge of the second part 5b. When the slide rail cover 22 is removed, the slide rail 21 is freely accessible, which is advantageous when servicing, for example. At one side facing the first part 5A, the slide rail cover 22 can likewise have a seal, which is preferably formed by means of the lip arrangement described above.

The embodiment forms described above are provided with swivel leaf drives 10. Instead of the swivel leaf drives 10 or in addition to them, door closers can be used. Of course, the drive modules 5 which are described in a household appliance 1b by way of example can be applied to all other embodiment forms described herein.

The operative couplings described above can also be applied to all of the embodiment forms described herein.

The arrangements described with reference to pieces of furniture 1a, particularly with respect to the swivel leaf drives 10, can also be applied to the household appliances 1b described above.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A furniture or household appliance comprising:
at least one swiveling door leaf; and
at least one of a door closer or swivel leaf drive coupled to the at least one swiveling door leaf, wherein the at least one door closer or swivel leaf drive has a driven shaft which is in an operative connection to the at least one swiveling door leaf such that a rotation of the driven shaft causes a swiveling of the at least one swiveling door leaf.

2. The furniture or household appliance according to claim 1, further comprising a first hinge having two flaps, wherein the driven shaft is coupled to at least one of the flaps of the first hinge so as to be fixed with respect to relative rotation wherein the hinge and the at least one swiveling door leaf is swivelably mounted at an upright part of the furniture or household appliance.

3. The furniture or household appliance according to claim 2, further comprising a second hinge having two flaps, wherein a connection piece is arranged between the first and second hinges and coupled to at least one flaps of each of the first and second hinges.

4. The furniture or household appliance according to claim 3, wherein the connection piece is coupled to the driven shaft.

5. The furniture or household appliance according to claim 2, wherein the at least one flap is arranged at the at least one swiveling door leaf in a stationary manner, and the at least one door closer or swivel leaf drive is arranged in a stationary manner at an upright part of the furniture or household appliance.

6. The furniture or household appliance according to claim 4, wherein the at least one flap is arranged at the upright part of the furniture or household appliance in a stationary manner and the at least one door closer or swivel leaf drive is arranged in a stationary manner with respect to the at least one swiveling door leaf.

7. The furniture or household appliance according to claim 1, wherein a sliding arm is arranged at one end of the drive shaft and fixed with respect to rotation relative to the drive shaft at a first end and is mounted at a second end, remote from the drive shaft, in a slide rail.

8. The furniture or household appliance according to claim 1, wherein the at least one door closer or swivel leaf drive is arranged in at least one of an upper or lower portion of the upright part of the furniture or household appliance.

9. The furniture or household appliance according to claim 8, wherein the at least one door closer or swivel leaf drive is provided with a panel part.

10. The furniture or household appliance according to claim 9, wherein the panel part is provided with a cover.

11. The furniture or household appliance according to claim 8, wherein the at least one door closer or swivel leaf drive is received in a completely closed receiving space of the furniture or household appliance.

12. The furniture or household appliance according to claim 11, wherein the at least one door closer or swivel leaf drive is accommodated in a first part of a module, wherein the module has a second part which is operatively coupled to the at least one door closer or swivel leaf drive, wherein the first part is arranged in a stationary manner at the upright part and the second part is arranged in a stationary manner at the swiveling door leaf.

13. The furniture or household appliance according to claim 1, further comprising at least one cover.

14. The furniture or household appliance according to claim 2, wherein the at least one door closer or swivel leaf drive is arranged so as to be usable at a DIN-right-handed swiveling door as well as at a DIN-left-handed swiveling door.

15. The furniture or household appliance according to claim 3, wherein the door closer or swivel leaf drive is coupled to at least one swivel door leaf via a drive portion.

16. The furniture or household appliance of claim 15, wherein the drive portion is a polygon.

17. The furniture or household appliance of claim 15, wherein the drive portion is a threaded connection.

18. The furniture or household appliance of claim 15, wherein the drive portion is a thickened region.

20. A household assembly comprising:
a body;
a first hinge segment coupled to the body;
a second hinge segment coupled to the first hinge segment;
a swiveling door leaf coupled to the second hinge segment;
a drive portion coupled to the first and second hinge portions, wherein the driven portion is fixed to the one of the first and second hinge portions with respect to motion.

21. The housing assembly of claim 20, further comprising a driving means affixed to the body coupled to the drive portion adapted to move the swiveling door leaf between an opened and a closed position.

22. The housing assembly of claim 21, wherein the drive portion is fixed to the one of the first and second hinge portions via a drive connection selected from the group consisting of a polygon connection, a threaded connection, a press-fit connection, a tension connection, and a pin.
